(19) United States
(12) Patent Application Publication
(10) Pub. No.: US 2025/0187583 A1
(43) Pub. Date: Jun. 12, 2025

(54) ALTERNATOR WITH VISCOUS TECHNOLOGY

(71) Applicant: CNH Industrial (India) Private Limited, Gurgaon (IN)

(72) Inventors: Sunil BISHNOI, Hisar (IN); Yogesh, Rewari (IN); Laxmi Narayan Dass Goel, Kurukshetra (IN)

(73) Assignee: CNH Industrial (India) Private Limited, Gurgaon (IN)

(21) Appl. No.: 18/977,674

(22) Filed: Dec. 11, 2024

(30) Foreign Application Priority Data
Dec. 12, 2023 (IN) 202311084753

(51) Int. Cl. B60W 20/13; B60W 10/02; B60W 10/08; B60W 10/26

(52) U.S. Cl. CPC B60W 20/13; B60W 10/02; B60W 10/08; B60W 10/26; B60W 2300/152; B60W 2510/244; B60W 2710/021; B60W 2710/244

(57) ABSTRACT

Embodiments of the present invention provide a method for increasing the operational efficiency of an energy conversion device in a vehicle. The method includes receiving a threshold value corresponding to the energy state of an energy storage device, as well as an indication of an energy state of the energy storage device and the operational state of the energy conversion device. The method further involves determining if the indication of the energy state exceeds the threshold value. In response to determining that the energy state exceeds the threshold value and the energy conversion device is in a charging state, a control signal is transmitted to engage a clutch mechanism, thereby decoupling the energy conversion device from a shaft mechanically connected to the vehicle's drive mechanism.

### CROSS-REFERENCE TO RELATED PATENT APPLICATION

This application claims the benefit of and the priority to Indian Patent Application 202311084753, filed on Dec. 12, 2023, the entire disclosure of which is incorporated by reference herein.

### BACKGROUND

Efficient energy conversion in vehicles is crucial for increasing performance and reducing fuel consumption. In traditional vehicles, an alternator is a source of inefficiency as it constantly runs during the vehicle's operation, even when it is not needed. Thus, it draws power unnecessarily from the drivetrain of the vehicle. A need exists to increase the efficiency of traditional vehicles with a selective operation of the alternator.

### SUMMARY

The present disclosure is directed to a method, system, and apparatus that satisfies this need. In one embodiment, an energy conversion device of a vehicle is coupled to a drive system by a clutch mechanism. The clutch mechanism is communicably coupled to a controller, the controller being communicably coupled to at least an energy storage device. The controller is configured to determine an energy status of the energy storage device electrically coupled to the energy conversion device and engage the clutch mechanism (thereby disengaging the energy conversion device from the drive system) upon determining that the energy status of the energy storage device exceeds a predetermined threshold.

In some aspects, the techniques described herein relate to a method for increasing operational efficiency of an energy conversion device of a vehicle including: receiving, by one or more processors, a threshold value corresponding to an energy state of an energy storage device; receiving, by the one or more processors, an indication of the energy state of the energy storage device and an operational state of the energy conversion device; determining, by the one or more processors, if the indication of the energy state of the energy storage device exceeds the threshold value; and responsive to determining that the indication of the energy state of the energy storage device exceeds the threshold value and the energy conversion device is in a charging state, transmitting, by the one or more processors, a control signal to engage a clutch mechanism to decouple the energy conversion device from a shaft mechanically coupled to a drive mechanism of the vehicle.

In some aspects, the techniques described herein relate to a method, further including: receiving, by the one or more processors, a second threshold value corresponding to a second energy state of the energy storage device; determining, by the one or more processors, if the indication of the energy state of the energy storage device exceeds the second threshold value; and responsive to determining that the indication of the energy state of the energy storage device does not exceed the threshold value and the energy conversion device is in a non-charging state, transmitting, by the one or more processors, a second control signal to the clutch mechanism to disengage the clutch mechanism to fluidly couple the energy conversion device to the shaft mechanically coupled to the drive mechanism of the vehicle.

In some aspects, the techniques described herein relate to a method, wherein the threshold corresponds to a fully charged energy storage device.

In some aspects, the techniques described herein relate to a method, wherein the one or more processors receive the indication of the energy state of the energy storage device at predetermined intervals during an operation of the vehicle.

In some aspects, the techniques described herein relate to a method, wherein the threshold value corresponds to a capacity of a starter motor operationally coupled to the vehicle.

In some aspects, the techniques described herein relate to a method, wherein the energy storage device is electrically coupled to a starter motor that is operationally coupled to the vehicle.

In some aspects, the techniques described herein relate to a method, wherein the vehicle is a tractor.

In some aspects, the techniques described herein relate to a vehicle including: an energy conversion device; an energy storage device; and processing circuitry, including one or more processors and a non-transitory computer-readable medium that, when executed by the one or more processors, cause the one or more processors to: receive, by the one or more processors, a threshold value corresponding to an energy state of the energy storage device; receive, by the one or more processors, an indication of the energy state of the energy storage device and an operational state of the energy conversion device; determine, by the one or more processors, if the indication of the energy state of the energy storage device exceeds the threshold value; and responsive to determining that the indication of the energy state of the energy storage device exceeds the threshold value and the energy conversion device is in a charging state, transmit, by the one or more processors, a control signal to engage a clutch mechanism to decouple the energy conversion device from a shaft mechanically coupled to a drive mechanism of the vehicle.

In some aspects, the techniques described herein relate to a vehicle, wherein the non-transitory computer-readable medium further causes the one or more processors to: receive, by the one or more processors, a second threshold value corresponding to a second energy state of the energy storage device; determine, by the one or more processors, if the indication of the energy state of the energy storage device exceeds the second threshold value; and responsive to determining that the indication of the energy state of the energy storage device does not exceed the threshold value and the energy conversion device is in a non-charging state, transmit, by the one or more processors, a second control signal to the clutch mechanism to disengage the clutch mechanism to fluidly couple the energy conversion device to the shaft mechanically coupled to the drive mechanism of the vehicle.

In some aspects, the techniques described herein relate to a vehicle, wherein the threshold corresponds to a fully charged energy storage device.

In some aspects, the techniques described herein relate to a vehicle, wherein the one or more processors receive the indication of the energy state of the energy storage device at predetermined intervals during an operation of the vehicle.

In some aspects, the techniques described herein relate to a vehicle, wherein the threshold value corresponds to a capacity of a starter motor operationally coupled to the vehicle.

In some aspects, the techniques described herein relate to a vehicle, wherein the energy storage device is electrically coupled to a starter motor that is operationally coupled to the vehicle.

In some aspects, the techniques described herein relate to a vehicle, wherein the vehicle is a tractor.

In some aspects, the techniques described herein relate to a system for increasing an efficiency of a work vehicle including: the work vehicle an energy conversion device; an energy storage device; and processing circuitry, including one or more processors and a non-transitory computer-readable medium that, when executed by the one or more processors, cause the one or more processors to: receive, by the one or more processors, a threshold value corresponding to an energy state of the energy storage device; receive, by the one or more processors, an indication of the energy state of the energy storage device and an operational state of the energy conversion device; determine, by the one or more processors, if the indication of the energy state of the energy storage device exceeds the threshold value; and responsive to determining that the indication of the energy state of the energy storage device exceeds the threshold value and the energy conversion device is in a charging state, transmit, by the one or more processors, a control signal to engage a clutch mechanism to decouple the energy conversion device from a shaft mechanically coupled to a drive mechanism of the work vehicle.

In some aspects, the techniques described herein relate to a system, wherein the non-transitory computer-readable medium further causes the one or more processors to: receive, by the one or more processors, a second threshold value corresponding to a second energy state of the energy storage device; determine, by the one or more processors, if the indication of the energy state of the energy storage device exceeds the second threshold value; and responsive to determining that the indication of the energy state of the energy storage device does not exceed the threshold value and the energy conversion device is in a non-charging state, transmit, by the one or more processors, a second control signal to the clutch mechanism to disengage the clutch mechanism to fluidly couple the energy conversion device to the shaft mechanically coupled to the drive mechanism of the work vehicle.

In some aspects, the techniques described herein relate to a system, wherein the threshold corresponds to a fully charged energy storage device.

In some aspects, the techniques described herein relate to a system, wherein the one or more processors receive the indication of the energy state of the energy storage device at predetermined intervals during an operation of the work vehicle.

In some aspects, the techniques described herein relate to a system, wherein the threshold value corresponds to a capacity of a starter motor operationally coupled to the work vehicle.

In some aspects, the techniques described herein relate to a system, wherein the energy storage device is electrically coupled to a starter motor that is operationally coupled to the work vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a driveline of the vehicle of FIG. 1, according to an exemplary embodiment.

FIG. 4A is a schematic block diagram of a control system of the vehicle of FIG. 1, according to an exemplary embodiment.

FIG. 4B is a schematic block diagram of a control system of the vehicle of FIG. 1, according to an exemplary embodiment.

FIG. 5 is an illustrative flow diagram of a process for controlling an energy conversion device to increase efficiency of a vehicle, according to an exemplary embodiment.

FIG. 6A is an illustrative flow diagram of a process for controlling an energy conversion device to increase efficiency of a vehicle, according to an exemplary embodiment.

FIG. 6B is an illustrative flow diagram of a process for controlling an energy conversion device to increase efficiency of a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

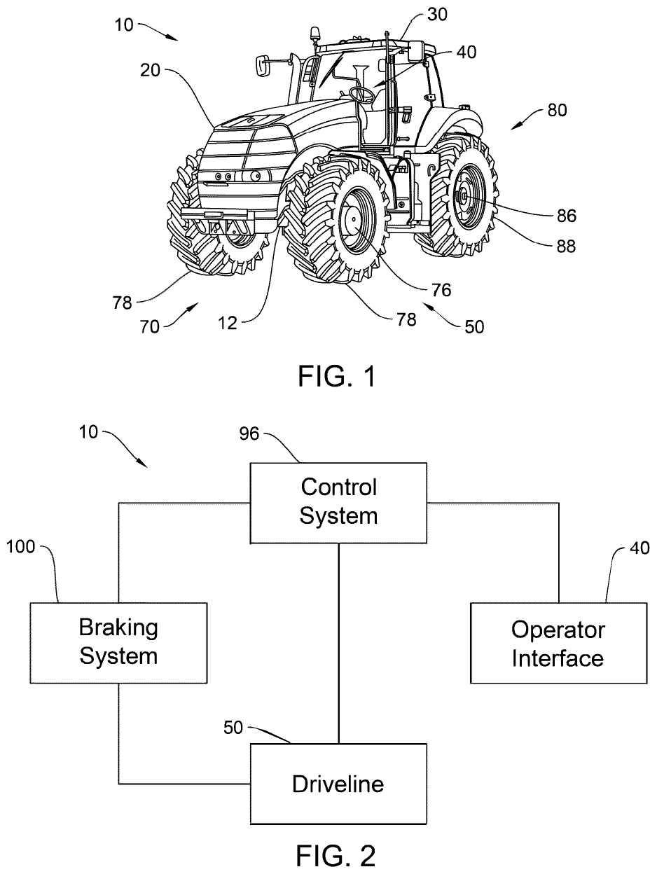

According to the exemplary embodiment shown in FIGS. 1-3, a machine or vehicle, shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 100, coupled to one or more components of the driveline 50 to facilitate selectively braking the one or more components of the driveline 50; and a vehicle control system, shown as control system 96, coupled to the operator interface 40, the driveline 50, and the braking system 100. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 52) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc.

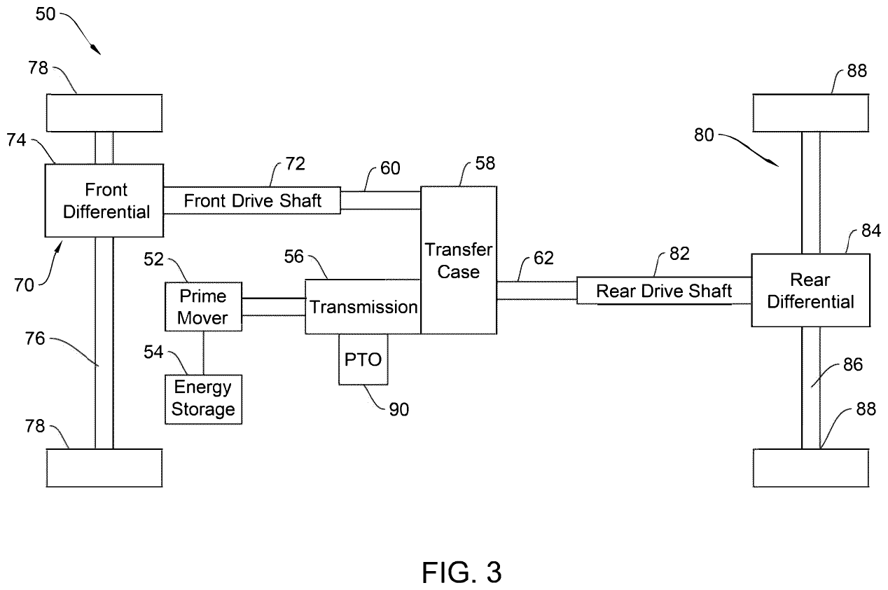

According to an exemplary embodiment, the driveline 50 is configured to propel the vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of prime movers 52. By way of example, the driveline 50 may include a first prime mover 52 that drives the front tractive assembly 70 and a second prime mover 52 that drives the rear tractive assembly 80. By way of another example, the driveline 50 may include a first prime mover 52 that drives a first one of the front tractive elements 78, a second prime mover 52 that drives a second one of the front tractive elements 78, a third prime mover 52 that drives a first one of the rear tractive elements 88, and/or a fourth prime mover 52 that drives a second one of the rear tractive elements 88. By way of still another example, the driveline 50 may include a first prime mover that drives the front tractive assembly 70, a second prime mover 52 that drives a first one of the rear tractive elements 88, and a third prime mover 52 that drives a second one of the rear tractive elements 88. By way of yet another example, the driveline 50 may include a first prime mover that drives the rear tractive assembly 80, a second prime mover 52 that drives a first one of the front tractive elements 78, and a third prime mover 52 that drives a second one of the front tractive elements 78. In such embodiments, the driveline 50 may not include the transmission 56 or the transfer case 58.

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### Energy Conversion and Storage System

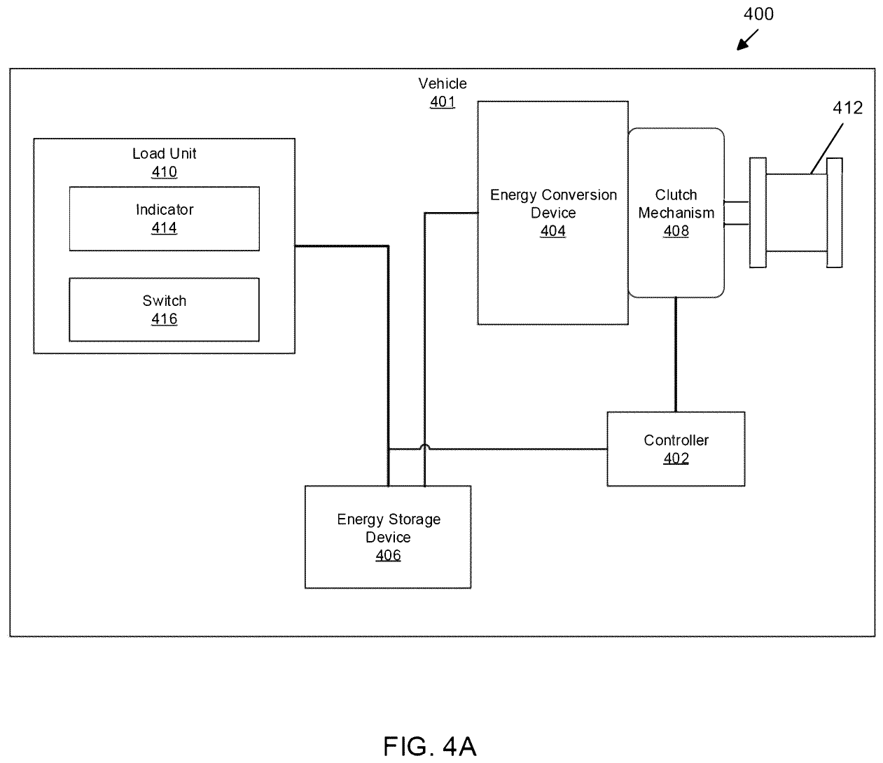

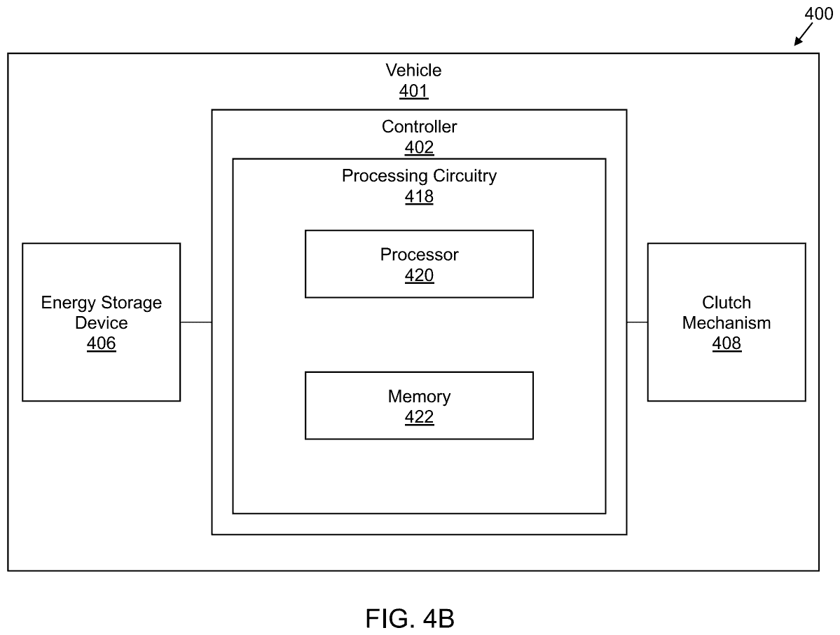

Turning now to FIG. 4A, a schematic block diagram of an energy conversion system 400 for a vehicle 401 is shown. In some embodiments, the vehicle 401 is the vehicle 10 of FIG. 1. The energy conversion system 400 may be used to optimize the efficiency of the vehicle 401. The energy conversion system 400 may include various components including, but not limited to, a controller 402, an energy conversion device 404, an energy storage device 406, a clutch mechanism 408, a load unit 410, and/or a drive mechanism 412. While shown in FIG. 4A as including these components, it is understood that the system 400 may include more, less, or different components than shown in FIG. 4A. For ease of description and understanding, FIG. 4A depicts the system 400 as having only one or a small number of each component. Embodiments may, however, comprise additional or alternative components, or omit certain components from those of FIG. 4A, and still fall within the scope of this disclosure. As an example, it may be common for embodiments to include multiple controllers 402 that are communicatively coupled to each other. Embodiments may include or otherwise implement any number of devices capable of performing the various features and tasks described herein.

In an exemplary embodiment, the energy conversion system 400 may be used to operationally control, by the controller 402, the energy conversion device 404 through a selectably controllable engagement and/or disengagement of the clutch mechanism 408.

The controller 402 is illustrated in greater detail in FIG. 4B. Turning now to FIG. 4B, the controller 402 and its various components are shown. The controller 402 may include processing circuitry 418. The processing circuitry 418 may include one or more processors 420 and a memory 422. The memory 422 may include non-transitory computer-readable storage medium containing instructions that, when executed by the processor 420, cause the processor 420 to perform various steps, methods, and/or processes disclosed herein. The various components of the controller 402 are communicatively coupled to each other and allow for transmission and reception of data signals.

Turning back to FIG. 4A, the controller 402 may be located on the vehicle 401 or may be located remote to the vehicle 401. In embodiments in which the controller 402 is located remote to the vehicle 401, the controller 402 may include one or more communication modules (not shown) that may be in communication with a local controller of the vehicle 401 that is communicatively coupled to the energy storage device 406, the clutch mechanism 408 and/or the energy storage device 406.

The controller 402 is communicatively coupled to the energy conversion device 404, the energy storage device 406, and/or the clutch mechanism 408. The controller 402 may be wiredly coupled to the energy storage device 406 and/or the clutch mechanism 408. Alternatively, and/or additionally, the controller 402 may be wirelessly coupled to the energy storage device 406 and/or the clutch mechanism 408. In embodiments in which the controller 402 is wirelessly coupled to the various other components, the controller 402 may include a communications module configured to transmit communication signals wirelessly to one or more devices. These communication signals may be sent by way of any suitable wireless communication protocol, such as Wi-Fi, cellular, Bluetooth, etc. The controller 402 may be configured to receive various data and information from the energy conversion device 404, the energy storage device 406, and the clutch mechanism 408.

From the energy conversion device 404, the controller 402 receives operational state information. In an exemplary embodiment, the energy conversion device 404 is an alternator of the vehicle 401. The energy conversion device 404 may generate electrical power to operate various equipment/accessories of the vehicle 401 (e.g., the load unit 410) and/or the energy storage device 406. In an exemplary embodiment, the energy conversion device 404 is not electrically coupled directly to the load unit 410, but rather, the energy conversion device 404 is electrically coupled to the energy storage device 406, which in turn powers the load unit 410. In an illustrative embodiment, the energy conversion device 404 comprises a rotor and a stator. The rotor is connected to a prime mover (e.g., an engine or motor) of the vehicle 401 through the clutch mechanism 408. The energy conversion device 404 is turned by the mechanical power of the prime mover of the vehicle 401. This turning of the rotor induces a magnetic field through a field coil on the rotor. As the rotor spins, the changing magnetic field causes the stator, with its sets of windings, to generate an alternating current (“AC”).

In some embodiments, the AC output is rectified into direct current (“DC”) using a rectifier, typically made up of diodes. This DC voltage is then regulated to maintain a consistent electrical supply, typically around 12 volts. However, the DC voltage may be regulated to any voltage used by the load unit 410 and/or the energy storage device 406. The regulated DC output of the energy conversion device may serve multiple purposes on the vehicle 401. These may include powering the vehicle's lighting, ignition system, and other electrical components. It also charges the energy storage device 406. The energy conversion device 404 provides the electrical energy to operate auxiliary components and implements. The vehicle 401 may be equipped with a variety of implements and equipment that require electrical power, such as plows, mowers, and hydraulic systems. The energy conversion device 404 provides the necessary electrical energy to power these implements and equipment.

The energy conversion device 404 may be configured to transmit data signals to the controller 402 automatically or upon receiving a request from the controller 402 for information. For example, the controller may periodically poll the energy conversion device 404 for data related to the operational state of the energy conversion device 404. In one embodiment, the energy conversion device 404 is either in an “on” state (e.g., running) or a “off” state (e.g., not running). In this embodiment, the energy conversion device 404 transmits a status or flag to the controller 402 corresponding to the operational state (e.g., “1” for the on state and “0” for the off state). This transmission of data may be transmitted periodically at predetermined intervals, transmitted in response to a request from the controller 402, transmitted upon a change in state of the energy conversion device 404, and/or transmitted upon a change in state of a separate component.

In other embodiments, the energy conversion device 404 may have more or less operational states. For example, the energy conversion device 404 may function variably. In other words, the energy conversion device 404 may variably operate at different speeds based on varying operating parameters and requirements/requests of the energy conversion device 404. By way of example, the energy conversion device 404 may work at variable speeds, with a maximum speed corresponding to maximum electrical output and a minimum speed corresponding to a minimum electrical output. The energy conversion device 404 may be gearedly coupled to the drive mechanism 412 with a transmission to allow the energy conversion device 404 operate as a varying speeds in relation to the drive mechanism 412 speed. The energy conversion device 404 may be configured to determine the operating speed of the energy conversion device 404 and transmit the determined speed to the controller 402. In other embodiments, the energy conversion device 404 may be coupled to the drive mechanism 412 by a continuously variable transmission.

In other embodiments, the energy conversion device 404 may have additional operating states. For example, the energy conversion device 404 may be configured with various switches and relays to transmit the converted energy to the energy storage device 406 (e.g., a “charging state”), various load units 410 (e.g., a starter motor), and/or implements of the vehicle 401. It is noted that FIG. 4A does not illustrate the various electrical/communicative paths through which the energy conversion device 404 may transmit data or electricity. In FIG. 4A, the energy conversion device 404 is shown electrically coupled to the energy storage device 406, though the energy conversion device 404 may also be electrically coupled to one or more other devices (e.g., the load unit 410), implements, or accessories. The energy conversion device 404 may have various operating states, each corresponding to a pathway of energy transmission. The energy conversion device 404 may have a controller executing software applications to make the determination of which operating state the energy conversion device 404 is operating in and to make the changes necessary to switch from one operating state to another. In other embodiments, the controller 402 makes the determination to which operational state the energy conversion device 404 is to operate in based on load requirements, the energy storage device 406 requirements, and/or user interactions with a user interface communicably to the controller 402.

While the energy conversion device 404 is described as transmitting various data related to the operational state of the energy conversion device 404, it should be understood that the controller 402 may determine the operational state based on one or more sensors communicably coupled to the controller and configured to measure one or more operating parameters (e.g., speed, rotation, switch placement, etc.) of the energy conversion device 404. In such embodiments, the energy converting device 404 need not transmit the operating status information to the controller 402.

As discussed herein, the energy conversion device 404 may operate to convert the mechanical/rotational energy of the drive mechanism 412 into electrical energy to charge the energy storage device 406 of the vehicle 401. According to an exemplary embodiment, the energy storage device 406 is a battery. The energy storage device 406 may be one of a variety of batteries including, but not limited to, lead-acid, nickel-metal hydride, nickel-cadmium, solid state batteries, etc. Additionally, or alternatively, the energy storage device 406 may be an ultracapacitor or supercapacitor. In some embodiments, the energy storage device 406 may include one or more of the above-mentioned energy storage devices. For example, the vehicle 401 may include a lead-acid battery operating in tandem with a supercapacitor.

The energy storage device 406 may be communicatively coupled to at least the controller of 402 and the energy conversion device 404. In some embodiments, the energy storage device 406 may be communicatively coupled to the energy conversion device 404, the clutch mechanism 408, and/or the load unit 410. The energy storage device 406 may be electrically coupled to controller 402, the energy conversion device 404, the clutch mechanism 408, and/or the load unit 410. The energy storage device may solely (or in conjunction with the energy conversion device 404) supply electrical energy to the load unit 410.

The energy storage device 406 may have one or more energy states. For example, the energy storage device 406 may have a variable energy state range corresponding to the percentage of energy stored in the energy storage device 406 with respect to the full energy storage capacity of the energy storage device 406. By way of example, the energy storage device 406 may have an energy state range from 0-100%. The 0% energy state of the energy storage device 406 may correspond to a completely depleted energy storage device 406 in which the energy storage device 406 holds no electrical charge. The 100% energy state of the energy storage device 406 may correspond to a completely full energy storage device 406 in which the energy storage device 406 is charged to its full capacity. The energy storage device 406 may include one or more additional energy states, for example, the energy storage device 406 may have a minimum operating state which may correspond to a minimum amount of charge that the energy storage device 406 must be charged to in order to operate one or more components of the vehicle 401 (e.g., the load unit 410).

Additionally, or alternatively, the energy storage device 406 may have more operating states. For example, the energy storage device 406 may have a discharge state in which the energy storage device 406 is discharging electrical energy to one or more component of the vehicle 401. The energy storage device 406 may also have a charging state in which the energy storage device 406 is receiving electrical energy from the energy conversion device or alternative charging device. The energy storage device 406 may also have a non-charging state in which the energy storage device 406 is not receiving electrical energy from the energy conversion device 404 or the alternative charging device. The energy storage device 406 may have temperature operating states. For example, the energy storage device 406 may have a heated state in which the energy storage device 406 is operating at an elevated temperature above a certain temperature threshold. Likewise, the energy storage device 406 may have a cooled state in which the energy storage device 406 is operating at a lower temperature below a certain second temperature threshold.

The energy storage device 406 may be configured to transmit information and/or data to the controller 402. This information or data may correspond to the various states of the battery as described herein. In some embodiments, the energy storage device 406 may be configured to transmit the data and/or information to the energy conversion device 404. This transmission of data may be transmitted periodically at predetermined intervals, transmitted upon startup of the vehicle 401, transmitted in response to a request from the controller 402 (or energy conversion device 404), transmitted upon a change in state of the energy conversion device 404, and/or transmitted upon a change in state of a separate component (e.g., the load unit 410).

The clutch mechanism 408 may be operationally coupled to the energy conversion device 404 and the drive mechanism 412. The clutch mechanism 408 may be used to selectively couple and decouple the energy conversion device 404 to the drive mechanism 412. In various embodiments, the drive mechanism 412 is attached to the prime mover of the vehicle 401 and is used to drive the energy conversion device 404 for operation. The clutch mechanism 408 may be used in a disengaged state to couple the drive mechanism 412 to the energy conversion device 404. The clutch mechanism 408 may be used in an engaged state to decouple the drive mechanism 412 to the energy conversion device 404. In various embodiments, the clutch mechanism is a viscous unit. In such embodiments, the viscous unit is a viscous clutch comprising a flywheel, a clutch plate, a support plate, a pressure plate, a pressure cap, one or more springs, friction linings, and/or a viscous fluid. One or more actuators may be used to selectively engage and disengage the clutch mechanism 408.

By way of example, the clutch actuator is coupled to the controller 402. Upon receiving a signal to engage the clutch mechanism 408, the actuator begins actuating in a first direction, thus initiating an engagement process which selectably decouples the energy conversion device 404 from the drive mechanism 412. The actuator may be a hydraulic, mechanical, pneumatic, and/or electromechanical actuator. Hydraulic, mechanical, or pneumatic forces are applied to the clutch release bearing, which pushes against the pressure plate, releasing the pressure on the clutch disc. As a result, the clutch disc is allowed to spin freely between the flywheel (which is coupled to the drive mechanism 412) and the pressure plate, effectively disconnecting the drive mechanism 412 from the energy conversion device energy conversion device 404.

Alternatively, upon receiving a signal to disengage the clutch mechanism 408, the actuator begins actuating in a second direction, thus initiating a disengagement process which selectably couples the energy conversion device 404 from the drive mechanism 412. The hydraulic, mechanical, and/or pneumatic forces are relieved, causing the clutch release bearing to move away from the pressure plate. In response, the diaphragm springs in the pressure plate apply pressure to the clutch disc, clamping it between the flywheel and the pressure plate. This disengagement couples the energy conversion device 404 to the drive mechanism 412, enabling power from the drive mechanism 412 (e.g., the engine) to be transferred to the energy conversion device 404. It should be noted that the energy conversion device 404 may be coupled to any moving mechanism of the vehicle 401. For example, the energy conversion device 404 may be selectably coupled by the clutch mechanism 408 to an axle of the vehicle 401 to be used in conjunction with regenerative braking. In some embodiments, the drive mechanism 412 is a pulley which is cooperatively coupled to the prime mover of the vehicle 401 by one or more belts. In some embodiments, the clutch mechanism 408 is a mechanical clutch.

The load unit 410 of the vehicle 401 may be any component or implement attached on or to the vehicle 401. By way of example, the load unit 410 may be a starter motor of the vehicle 401. The load unit 410 may include an indicator 414 for use in indicating operation of the load unit 410 and/or information related to the load unit (e.g., operation status, operating parameters status, position, maintenance codes, etc.). In addition, or alternatively, the load unit 410 may include a switch 416 which may be used to selectively operate the load unit 410. By way of example, the switch 416 may be an ignition that is used to initiate operation of the load unit 410 (e.g., the starter motor). The switch 416 may be any user interface which may be configured to receive an interaction from a user or processor of the vehicle 401. Additionally, or alternatively, the switch 416 may be communicatively coupled to the controller 402 and be configured to receive a transmission of control signals from the controller 402 to selectively operate the load unit 410. In some embodiments, the switch 416 is an electrical relay. The indicator 414 may be a visual indicator, an audible indicator, or a haptic indicator.

While the load unit 410 is described as the starter motor of the vehicle 401, it should be understood that the load unit 410 may be any component and/or implement of the vehicle 401. An exemplary, but not limiting, list of additional components and implements of the vehicle 401 include and then ignition system, lights, electrical accessories, and instrument cluster, electronic control unit, an engine control unit, fuel pumps, cooling fans, heating ventilation and air conditioning, power steering, sensors and control modules, and safety systems. These systems may be powered by the energy storage device 406 and/or the energy conversion device 404 directly during operation.

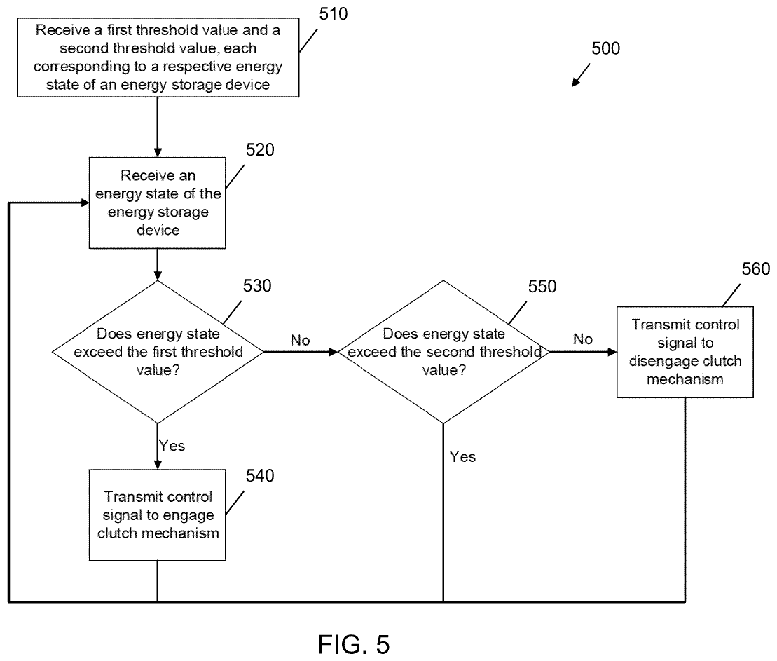

In various exemplary embodiments, the controller 402 is configured to determined based on one or more inputs whether to engage or disengage the energy conversion device from the drive mechanism 412 by the clutch mechanism 408. This process is described in FIG. 5 as process 500.

Turning now to FIG. 5 the process 500 is illustrated in an exemplary flow diagram. The process 500 begins with step 510 in which a controller is configured to receive a first threshold value and a second threshold value each corresponding to a respective energy state of an energy storage device. By way of example, the controller may be the controller 402 of FIG. 4A, and the energy storage device may be the energy storage device 406 of FIG. 4A. The first threshold value may correspond to a charging upper limit of the energy storage device. For example, the first threshold may correspond to an energy charge percent at which point the battery stops storing energy. This first threshold may correspond to a fully charged energy storage device or may correspond to an energy percentage below a fully charged energy state. In an exemplary embodiment the first threshold value is 95% charged (or a voltage corresponding to 95% charged). While the exemplary embodiment of the first threshold is 95% charge, it should be understood that the first threshold maybe any percentage within the ranges of 70% to 100% charge.

The second threshold value may correspond to a lower charging limit of the energy storage device. For example, the second threshold value may correspond to an energy charge percent at which point the battery begins storing energy from the energy converting device. Additionally, or alternatively, the second threshold value may correspond to a minimum charge amount needed to operate a load unit of the vehicle (e.g., a starter motor of the vehicle). In an exemplary embodiment, the second threshold value is 70% of the fully charged energy storage device. While the exemplary embodiment of the second threshold value is 70% charge, it should be understood that the second threshold may be any percentage of the fully charged energy storage device within the range of 0% to 80% charge.

The controller may receive the first threshold value and the second threshold value from one or more sources. For example, the controller may receive the first threshold value during programming of the memory of the controller. The controller may receive the first threshold value and the second threshold value from the load unit. For example, the load unit may transmit a signal to the controller with information indicating a minimum charge value needed to operate the load unit. While charge percentages of the energy storage device are used in describing the first threshold value and the second threshold value, it should be understood that the first threshold value and the second threshold value may correspond to any operating parameter of the energy storage device. For example, the first threshold value and the second threshold value may correspond to voltages or temperature instead of percentages. Likewise, the first threshold value and the second threshold value may correspond to voltages or amperes being supplied by the energy storage device to the load unit and/or voltages or amperes being supplied to the energy storage device from the energy conversion device.

At step 520, the controller receives an energy state of the energy storage device. The received energy state may be the current energy state of the energy storage device. For example, the received energy state of the energy storage device may be the current charge percentage of the energy storage device, the current temperature of the storage device, the current voltage and/or amperes being inputted into or outputted by the energy storage device. This data may be requested by the controller of the energy storage device through electronic communication. In some embodiments, the controller transmits a request for the data from the energy storage device and a controller of the energy storage device transmits the information back to the controller. In other embodiments the energy storage device transmits the energy state automatically to the controller in response to one or more triggers (e.g., a startup of the vehicle, the energy state reaching a threshold, another device requesting the data, etc.). In yet another embodiment, the energy storage device transmits the energy state at predetermined periodic intervals to the controller.

At step 530, the controller determines whether or not the energy state received from the energy storage device exceeds the first threshold value. At step 540, upon determining that the energy state received by the energy storage device exceeds the first threshold value, the controller transmits a control signal to engage a clutch mechanism (e.g., the clutch mechanism 408 of FIG. 4A) that is configured to selectably couple/decouple the energy conversion device to a drive mechanism (e.g., the drive mechanism 412 of FIG. 4A). According to an exemplary embodiment, the control signal transmitted to the clutch mechanism contains instructions that when executed by the clutch mechanism causes the clutch mechanism to decouple the energy conversion device from the drive mechanism. This may be accomplished by causing an actuator of the clutch mechanism to actuate and cause the clutch plate to move to a position such that a viscous fluid of the clutch mechanism no longer fluidly couples a flywheel to a clutch plate.

When the clutch mechanism is engaged, the drive mechanism is decoupled from the energy conversion device. This stops the movement (e.g., rotational movement) of the energy conversion device and the energy conversion device stops converting mechanical energy into electrical energy. In doing so, the energy converting device stops suppling electrical energy to the various components of the vehicle and/or charging the energy storage device.

In some embodiments, the controller transmits the control signal to engage the clutch mechanism responsive to determining that the energy state of the energy storage device exceeds the first threshold value, only when the energy conversion device is also not supplying converted, electrical energy to other components (e.g., the load unit) of the vehicle. In order to continue supplying converted, electrical energy to the other components, the controller does not transmit instructions to engage the clutch mechanism when the energy conversion device is supplying converted, electrical energy to the other components. In other embodiments, the energy conversion device does not supply converted, electrical energy to other components, and the controller transmits instructions to engage the clutch when the energy state of the energy storage device exceeds the first threshold value.

Upon transmitting the control signal to the clutch mechanism, the controller continues to receive the energy state of the energy storage device at step 520. If at step 530 The controller determines that the received energy state of the energy storage device does not exceed the first threshold value, the controller then determines whether the energy state of the energy storage device exceeds the second threshold value at step 550. If the controller determines that the received energy state of the energy storage device does exceed the second threshold value, the controller continues to step 520 to receive again the energy state of the energy storage device. If at step 550 the controller determines that the energy state of the energy storage device does not exceed the second threshold value, the controller continues to step 560. At step 560, the controller transmits a control signal to disengage the clutch mechanism. According to an exemplary embodiment, the control signal transmitted to the clutch mechanism at step 560 contains instructions that when executed by the clutch mechanism causes the clutch mechanism to couple the energy conversion device to the drive mechanism. This may be accomplished by causing an actuator of the clutch mechanism which is coupled (e.g., mechanically, pneumatically, hydraulically, electromechanically) to actuate and cause the clutch plate to move to a position such that a viscous fluid of the clutch mechanism fluidly couples the flywheel to the clutch plate, thus causing the drive mechanism to drive the energy conversion device.

Upon transmitting the control signal to the clutch mechanism to disengage the clutch mechanism, the controller continues to step 520 to receive the energy state of the energy storage device.

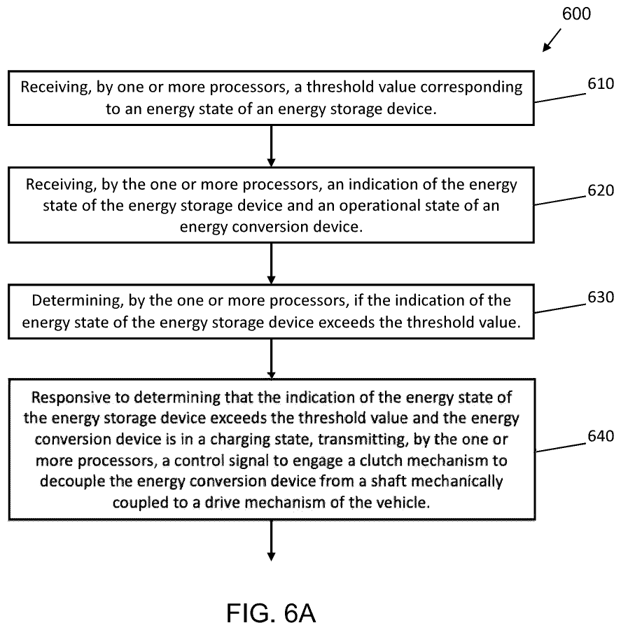

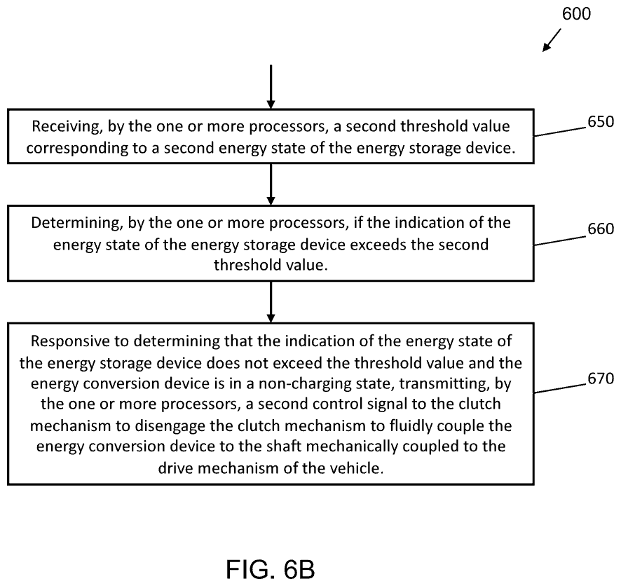

Turning now to FIG. 6A and FIG. 6B, a flowchart of an example process 600 for increasing operational efficiency of an energy conversion device of a vehicle. Embodiments may include additional, fewer, or different operations than those described in the process 600. The process 600 is performed by a controller (e.g., the controller 402 of FIG. 4A) comprising one or more processors executing machine-readable software code, though it should be appreciated that the various operations may be performed by one or more computing devices, servers, and/or processors. The process 600 may include various steps including, but not limited to, receiving, by one or more processors, a threshold value corresponding to an energy state of an energy storage device (Step 610). The one or more processors of the controller may receive the threshold value from a user or operator of the vehicle. Additionally, or alternatively, the one or more processors may receive the threshold value from the memory of the controller. The threshold value, according to an embodiment, may be a max charge percent or voltage of the energy storage device. For example, the threshold value may correspond to a voltage or charge percent at which the energy storage device no longer needs to receive electrical energy to charge.

At step 620, the process 600 continues by receiving, by the one or more processors, an indication of the energy state of the energy storage device and an operational state of the energy conversion device. The energy state of the energy storage device may correspond, in units, to the received threshold value. For example, if the received threshold value is a voltage, then the energy state may be a voltage. If the received threshold value is a battery percent, then the energy state may be a battery percent. The energy state may be associated with the current energy state of the energy storing device. In some embodiments, the energy state maybe in a different unit than the threshold value. In such embodiments, the one or more processors may convert the energy state and/or the threshold value to be the same unit.

The operational state of the energy conversion device may be an indication or associated with whether the energy conversion device is running or not running. Similarly, the operational state of the energy conversion device may be associated with a destination of energy transmitted from the energy conversion device. For example, the operational state may be associated with a charging state in which the energy conversion device is charging the energy storage device. The operational state may be associated with a power state in which the energy conversion device is providing power to one or more auxiliary components of the vehicle.

At step 630, the process 600 continues by determining, by the one or more processors, if the indication of the energy state of the energy storage device exceeds the threshold value. Upon receiving both the threshold value and the energy state of the energy storage device, the one or more processors compare the two values and determines if the threshold value is exceeded by the energy state of the energy storage device.

At step 640, the process 600 continues by, responsive to determining that the indication of the energy state of the energy storage device exceeds the threshold value and the energy conversion device is in a charging state, transmitting, by the one or more processors, a control signal to engage a clutch mechanism to decouple the energy conversion device from a shaft mechanically coupled to a drive mechanism of the vehicle. Upon the energy state exceeding the threshold value, the controller determines that the energy storage device is fully charged and/or the charging of the energy storage device is completed. In the event that the energy conversion device is charging the energy storage device when it is determined that the energy state of the energy storage device exceeds the threshold value, the controller determines that the energy conversion device no longer needs to charge the energy storage device. As such, the one or more processors of the controller transmits a control signal to the clutch mechanism to engage the clutch and thereby decouple the energy conversion device from the drive mechanism. In other embodiments, the controller transmits a control signal to the energy conversion device to transmit the converted energy to a destination other than the energy storage device. For example, the energy conversion device may transmit the converted energy to one or more auxiliary components of the vehicle.

Turning now to FIG. 6B, additional steps of the process 600 are illustrated. At step 650, the process 600 continues from step 640 by receiving, by the one or more processors, a second threshold value corresponding to a second energy state of the energy storage device. According to an exemplary embodiment, the second threshold value corresponds to a minimum charge state of the energy storage device. For example, the second threshold value may correspond to an energy requirement of one or more auxiliary components. For example, the second threshold value may correspond to the amount of energy needed to operate a starter motor of the vehicle. In some embodiments, this second threshold value is a value within a range above the required energy of the one or more auxiliary components to ensure sufficient energy to power the components.

At step 660, the process 600 continues by determining, by the one or more processors, if the indication of the energy state of the energy storage device exceeds the second threshold value.

At step 670, the process 600 continues by, responsive to determining that the indication of the energy state of the energy storage device does not exceed the threshold value and the energy conversion device is in a non-charging state, transmitting, by the one or more processors, a second control signal to the clutch mechanism to disengage the clutch mechanism to fluidly couple the energy conversion device to the shaft mechanically coupled to the drive mechanism of the vehicle. By coupling the drive mechanism of the vehicle to the energy conversion device, the machinal energy of the drive mechanism is again converted, by the energy conversion device, into electrical energy for charging the energy storage device. In some embodiments, the controller also sends a control signal to the energy conversion device to transmit the converted, electrical energy to the energy storage device.

According to an embodiment, the energy conversion device maybe an alternator which is configured to supply electrical energy to various auxiliary components of the vehicle and in order to charge the energy storage device. To increase efficiency of the vehicle, the energy conversion device is decoupled from the drive mechanism when the energy storage device is sufficiently charged and/or the energy conversion device is not supplying electrical energy to any auxiliary components of the vehicle. By decoupling the energy conversion device from the drive mechanism, the energy conversion device ceases drawing mechanical energy from the drive mechanism, thus increasing the efficiency of the vehicle. In some embodiments, the energy conversion device utilizes 1 horsepower of the vehicle in converting 25 amperes. By decoupling the energy conversion device from the drive mechanism when it is not needed, the vehicle may decrease its needed output by 1 horsepower. However, when the battery percentage drops below a predetermined threshold (e.g., an energy level requirement to run the starter motor of the vehicle), the controller sends a control signal to the clutch mechanism to disengage the clutch and thereby couple the engine of the vehicle to the alternator. By coupling the alternator to the engine, the alternator begins converting the mechanical energy back into electrical energy and thereby charging the battery.

In the disclosure presented herein, when one or more processors are described as executing or otherwise performing an action, it should be understood that this may include transmitting instructions for one or more subsystems of the vehicle 10 to perform the action.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative, or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a vehicle, a Global Positioning System (GPS) receiver, etc.). Devices suitable for storing computer program instructions and data include all forms of non-volatile memory, media, and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user. Other kinds of devices may be used to provide for interaction with a user as well; for example, feedback provided to the user may be any form of sensory feedback (e.g., visual feedback, auditory feedback, or tactile feedback).

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein.

1. A method for increasing operational efficiency of an energy conversion device of a vehicle comprising:
receiving, by one or more processors, a threshold value corresponding to an energy state of an energy storage device;
receiving, by the one or more processors, an indication of the energy state of the energy storage device and an operational state of the energy conversion device;
determining, by the one or more processors, if the indication of the energy state of the energy storage device exceeds the threshold value; and
responsive to determining that the indication of the energy state of the energy storage device exceeds the threshold value and the energy conversion device is in a charging state, transmitting, by the one or more processors, a control signal to engage a clutch mechanism to decouple the energy conversion device from a shaft mechanically coupled to a drive mechanism of the vehicle.

2. The method of claim 1, further comprising:
receiving, by the one or more processors, a second threshold value corresponding to a second energy state of the energy storage device;
determining, by the one or more processors, if the indication of the energy state of the energy storage device exceeds the second threshold value; and
responsive to determining that the indication of the energy state of the energy storage device does not exceed the threshold value and the energy conversion device is in a non-charging state, transmitting, by the one or more processors, a second control signal to the clutch mechanism to disengage the clutch mechanism to fluidly couple the energy conversion device to the shaft mechanically coupled to the drive mechanism of the vehicle.

3. The method of claim 1, wherein the threshold value corresponds to a fully charged energy storage device.

4. The method of claim 1, wherein the one or more processors receive the indication of the energy state of the energy storage device at predetermined intervals during an operation of the vehicle.

5. The method of claim 1, wherein the threshold value corresponds to a capacity of a starter motor operationally coupled to the vehicle.

6. The method of claim 1, wherein the energy storage device is electrically coupled to a starter motor that is operationally coupled to the vehicle.

7. The method of claim 1, wherein the vehicle is a tractor.

8. A vehicle comprising:
an energy conversion device;
an energy storage device; and
processing circuitry, including one or more processors and a non-transitory computer-readable medium that, when executed by the one or more processors, cause the one or more processors to:
receive a threshold value corresponding to an energy state of the energy storage device;
receive an indication of the energy state of the energy storage device and an operational state of the energy conversion device;
determine if the indication of the energy state of the energy storage device exceeds the threshold value; and
responsive to determining that the indication of the energy state of the energy storage device exceeds the threshold value and the energy conversion device is in a charging state, transmit a control signal to engage a clutch mechanism to decouple the energy conversion device from a shaft mechanically coupled to a drive mechanism of the vehicle.

9. The vehicle of claim 8, wherein the non-transitory computer-readable medium further causes the one or more processors to:
receive a second threshold value corresponding to a second energy state of the energy storage device;
determine if the indication of the energy state of the energy storage device exceeds the second threshold value; and
responsive to determining that the indication of the energy state of the energy storage device does not exceed the threshold value and the energy conversion device is in a non-charging state, transmit a second control signal to the clutch mechanism to disengage the clutch mechanism to fluidly couple the energy conversion device to the shaft mechanically coupled to the drive mechanism of the vehicle.

10. The vehicle of claim 8, wherein the threshold value corresponds to a fully charged energy storage device.

11. The vehicle of claim 8, wherein the one or more processors receive the indication of the energy state of the energy storage device at predetermined intervals during an operation of the vehicle.

12. The vehicle of claim 8, wherein the threshold value corresponds to a capacity of a starter motor operationally coupled to the vehicle.

13. The vehicle of claim 8, wherein the energy storage device is electrically coupled to a starter motor that is operationally coupled to the vehicle.

14. The vehicle of claim 8, wherein the vehicle is a tractor.

15. A system for increasing an efficiency of a work vehicle comprising:
the work vehicle
an energy conversion device;
an energy storage device; and
processing circuitry, including one or more processors and a non-transitory computer-readable medium that, when executed by the one or more processors, cause the one or more processors to:
receive a threshold value corresponding to an energy state of the energy storage device;
receive an indication of the energy state of the energy storage device and an operational state of the energy conversion device;
determine if the indication of the energy state of the energy storage device exceeds the threshold value; and
responsive to determining that the indication of the energy state of the energy storage device exceeds the threshold value and the energy conversion device is in a charging state, transmit a control signal to engage a clutch mechanism to decouple the energy conversion device from a shaft mechanically coupled to a drive mechanism of the work vehicle.

16. The system of claim 15, wherein the non-transitory computer-readable medium further causes the one or more processors to:
receive a second threshold value corresponding to a second energy state of the energy storage device;
determine if the indication of the energy state of the energy storage device exceeds the second threshold value; and
responsive to determining that the indication of the energy state of the energy storage device does not exceed the threshold value and the energy conversion device is in a non-charging state, transmit a second control signal to the clutch mechanism to disengage the clutch mechanism to fluidly couple the energy conversion device to the shaft mechanically coupled to the drive mechanism of the work vehicle.

17. The system of claim 15, wherein the threshold value corresponds to a fully charged energy storage device.

18. The system of claim 15, wherein the one or more processors receive the indication of the energy state of the energy storage device at predetermined intervals during an operation of the work vehicle.

19. The system of claim 15, wherein the threshold value corresponds to a capacity of a starter motor operationally coupled to the work vehicle.

20. The system of claim 15, wherein the energy storage device is electrically coupled to a starter motor that is operationally coupled to the work vehicle.
